(19) United States
(12) Patent Application Publication
(10) Pub. No.: US 2014/0030821 A1
(43) Pub. Date: Jan. 30, 2014

(54) LOCALIZED PLASMON ENHANCING FLUORESCENCE PARTICLES, LOCALIZED PLASMON ENHANCED FLUORESCENCE DETECTING CARRIER, LOCALIZED PLASMON ENHANCED FLUORESCENCE DETECTING APPARATUS, AND FLUORESCENCE DETECTING METHOD

(71) Applicant: FUJIFILM Corporation, Tokyo (JP)

(72) Inventor: Hisashi OHTSUKA, Ashigarakami-gun (JP)

(73) Assignee: FUJIFILM Corporation, Tokyo (JP)

(21) Appl. No.: 14/041,714

(22) Filed: Sep. 30, 2013

(30) Foreign Application Priority Data
Mar. 31, 2011 (JP) 2011-077040

(51) Int. Cl. G01N 21/64

(52) U.S. Cl. CPC G01N 21/6486
USPC 436/501; 422/70

(57) ABSTRACT

Enhancing fluorescent particles constituted by a plurality of fine metal particles and a plurality of fluorescent dye molecules dispersed and enveloped in a light transmitting dielectric material are employed. Here, the particle size of the fine metal particles is greater than 10 nm and 40 nm or less, and the volume within the enhancing fluorescent particles occupied by the fine metal particles is within a range from 5% to 40%.

### TECHNICAL FIELD

The present invention is related to localized plasmon enhancing fluorescence particles for use in fluorescence detection that utilizes localized plasmon enhancement, a localized plasmon enhanced fluorescence detecting carrier equipped with the localized plasmon enhancing fluorescence particles, a localized plasmon enhanced fluorescence detecting apparatus, and a fluorescence detecting method.

### BACKGROUND ART

The immunochromatography method is known as a method for detecting pathogenic viral antigens and other proteins, as disclosed in U.S. Pat. No. 5,591,645. The immunochromatography method employs a carrier (support), at a predetermined position of which a substance that reacts or binds with a detection target is immobilized. A sample having fine labeling particles capable of binding with the detection target mixed therein is delivered. In the case that the detection target is present and binds with the aforementioned substance, the fact that the labeling particles which are bound to the detection target will exhibit color at the predetermined position is utilized to detect the presence or amount of the detection target.

Demand for the immunochromatography method is rapidly increasing as a method capable of detecting simply and expediently pathogens and viruses that cause viral diseases such as influenza. Note that fine metal particles are generally employed as the fine labeling particles, and in this case, absorption of light having a specific wavelength by localized plasmon generated at the particles is utilized to exhibit color. Accordingly, the exhibited color can be varied to a certain degree by varying the particle size of the fine metal particles.

In addition, the fluorometry method is conventionally used in biological measurements and the like, as an easy and highly sensitive measuring method. In the fluorometry method, a sample, which is considered to contain a detection target substance that emits fluorescence when excited by light having a specific wavelength, is irradiated with an excitation light beam of the aforementioned specific wavelength. The presence of the detection target substance can be confirmed quantitatively by detecting the fluorescence due to the excitation. In the case that the detection target substance is not a fluorescent substance, a substance which is labeled with a fluorescent substance and specifically binds with the detection target substance is caused to contact the sample. Thereafter, fluorescence is detected in the same manner as described above, thereby confirming the presence of the detection target substance, by the presence of the bonds.

A method (evanescent fluorometry method) that causes excitation light which is totally reflected at a first surface of a substrate to enter the substrate from a second surface thereof, excites fluorescence with evanescent waves that seep onto the first surface, and detects the fluorescence excited by the evanescent waves is known as a method for detecting fluorescence emitted by fluorescent labels.

Further, an evanescent fluorometry method that utilizes the effects of electric field enhancement by plasmon resonance in order to improve sensitivity is proposed in U.S. Pat. No. 6,194,223. The surface plasmon enhanced fluorometry method causes plasmon resonance to occur. Therefore, a metal layer is provided on a first surface of a substrate, excitation light is caused to enter the interface between the substrate and the metal layer from a second surface of the substrate at a total reflection angle or greater. Surface plasmon are generated in the metal layer by irradiation of the excitation light and fluorescent signals are amplified by the electric field enhancing effects thereof, thereby improving S/N ratios.

In the surface plasmon enhanced fluorometry method, there is a problem that discoloration of dyes caused by intense energy being imparted thereto results in decreased sensitivity and decreased accuracy in quantification. Japanese Unexamined Patent Publication No. 2010-091553 proposes the use of fluorescent labels, in which dye molecules are enveloped in silica particles, as a method for solving this problem.

In addition, Japanese Unexamined Patent Publication No. 2010-019765 discloses the use of a fluorescent substance, in which a plurality of fluorescent dye molecules and one or more fine fluorescence enhancing particles are enveloped in a light transmitting material, as fluorescent labels in the plasmon enhanced fluorometry method, in order to further improve sensitivity. Note that fine scattering particles, fine metal particles, and metal nanorods are disclosed as examples of the fine fluorescence enhancing particles.

As described previously, it is possible to change the exhibited color in the immunochromatography method by varying the particle size of the fin metal particles, which are fine labeling particles. However, the absorption wavelength of localized plasmon of the fine metal particles is approximately 530 nm, resulting in a magenta color, which is not readily visually discerned by the human eye. Accordingly, it is difficult for the immunochromatography method to meet demand for high sensitivity detection capable of detecting amounts of substances of approximately several tens of pmol (pico mol).

In contrast, surface plasmon enhanced fluorescence sensors are capable of detecting substances in amounts of several fmol (femto mol), and can meet demand for high sensitivity detection. However, the apparatus is complex and the cost thereof is high, because a total reflection optical system having components such as prisms are necessary.

Therefore, the present applicants proposed a localized plasmon enhanced fluorescence measuring apparatus as a fluorescence sensor capable of high sensitive detection which can be produced at low cost that employs fine metal particles to utilize electric field enhancement by localized plasmon in U.S. Patent Application Publication No. 20080219893. In addition, the invention of U.S. Patent Application Publication No. 20080219893 causes metal particles enveloped in a non flexible film to bind with dye labeled antibodies to suppress a phenomenon in which energy excited within fluorescent dye transitions to a metal film and fluorescence is not generated if the fluorescent dye is too close to the metal film (metal quenching).

### DISCLOSURE OF THE INVENTION

The labels employed by the invention of U.S. Pat. No. 5,591,645 are those in which an antibody 105 imparted with a single dye molecule 104 is bound to a metal particle 103 enveloped by a non flexible film 102, as illustrated in FIG. 5. Signals are weak because the number of dye molecules 104 is small, and there is a problem that sufficiently high sensitivity cannot be obtained.

The present invention has been developed in view of the foregoing circumstances. It is an object of the present invention to provide localized plasmon enhancing fluorescence particles for use in a localized plasmon enhanced fluorescence detecting apparatus, capable of generating a higher electric field enhancing effect and generating a greater amount of fluorescence.

It is another object of the present invention to provide a localized plasma enhanced fluorescence detecting carrier equipped with the localized plasmon enhancing fluorescence particles, a localized plasmon enhanced fluorescence detecting apparatus, and a fluorescence detecting method.

A localized plasmon enhanced fluorescent particle of the present invention comprises:

a plurality of fine metal particles;

a plurality of fluorescent dye molecules; and

a light transmitting dielectric material;

the plurality of fine metal particles and the plurality of fluorescent dye molecules being dispersed and enveloped in the light transmitting dielectric material; and

the particle size of the fine metal particles being greater than 10 nm and 40 nm or less, and the volume occupied by the fine metal particles in the light transmitting dielectric material is within a range from 5% to 40%.

The particle size of the fine metal particles is defined as the longest dimension of the particles. Here, each particle among the plurality of fine metal particles has particle sizes within the above range. The percentage of volume occupied by the fine metal particles is calculated based on the volume occupied by all of the fine metal particles within the localized plasmon enhancing fluorescent particle, and is a percentage of volume of the fine metal particles per unit volume of the localized plasmon enhanced fluorescent particle.

It is preferable for the light transmitting dielectric material to be one of SiO₂ and a transparent resin.

Here, the expression “light transmitting” refers to a transmissivity with respect to fluorescence and with respect to the peak wavelength of excitation light that excites the fluorescence of 85% or greater.

Polymethyl methacrylate (PMMA) and cycloolefin series resins are preferable as the light transmitting resin, as they have superior light transmitting properties.

A localized plasmon enhanced fluorescence detecting carrier of the present invention comprises:

a sample holding member having a flow channel through which a sample fluid is caused to flow;

a sensor portion, at which a first binding substance that specifically binds with a detection target substance within the sample fluid is immobilized, provided within the flow channel; and

a labeling binding substance supply portion, at which a labeling binding substance is supplied, provided within the flow channel upstream of the sensor portion;

the labeling binding substance being one of a second binding substance that specifically binds with the detection target substance and a third binding substance that specifically binds with the first binding substance in competition with the detection target substance, to which enhanced fluorescent particles of the present invention are imparted.

A localized plasmon enhanced fluorescence measuring apparatus of the present invention comprises:

a localized plasmon enhanced fluorescence detecting carrier of the present invention;

a light source that irradiates excitation light that excites the fluorescent particles onto the sensor portion; and

light detecting means for detecting fluorescence emitted by the fluorescent particles excited by the excitation light.

A fluorescence detecting method of the present invention comprises:

causing a sample liquid to contact a sensor portion of a sample cell, a first binding substance that specifically binds with a detection target substance being immobilized on the sensor portion, and the sample liquid including a labeled binding substance, which is one of a second binding substance that specifically binds with the detection target substance and a third binding substance that specifically binds with the first binding substance in competition with the detection target substance, labeled with fluorescent labels;

irradiating light onto the sensor portion; and

detecting fluorescence emitted by the fluorescent labels, which are excited by the light being irradiated thereon;

enhanced fluorescent particles of the present invention being employed as the fluorescent labels, and fluorescence enhanced by localized plasmon resonance being detected.

The enhancing fluorescence particles for localized plasmon enhanced fluorescence detection of the present invention has a plurality of fine metal particles and a plurality of fluorescent dye molecules enveloped in the light transmitting material. The particle size of the fine metal particles is greater than 10 nm and 40 nm or less, and the volume occupied thereby within the enhancing fluorescent particles is within a range from 5% to 40%. Therefore, when the enhancing fluorescent particles are irradiated by light, localized plasmon resonance is generated by the fine metal particles, an enhancing electric field due to the localized plasmon resonance is generated about the peripheries of the fine metal particles, and fluorescence emitted by the fluorescent dye molecules is amplified by the enhancing electric field. A plurality of fluorescent dye molecules are enveloped within the enhancing fluorescent particles, and therefore the integrated amount of fluorescence becomes extremely large, and fluorescence is generated at high sensitivity with respect to irradiation of light. Note that because the fine metal particles and the fluorescent dye molecules are dispersed in the light transmitting dielectric material, there are some fluorescent dye molecules which are close enough to fine metal particles to cause metal quenching to occur. However, a plurality of fluorescent dye molecules which are not in close proximity to fine metal particles are also present. Therefore, the electric field enhancing effect due to the localized plasmon can be positively obtained, and amplified fluorescence can be generated.

The localized plasmon enhanced fluorescence detecting carrier is capable of detecting detection target substances at high sensitivity, because it is equipped with the enhancing fluorescent particles of the present invention.

The localized plasmon enhanced fluorescence detecting apparatus is capable of detecting detection target substances at high sensitivity, because it is equipped with the enhancing fluorescent particles of the present invention.

In addition, the localized plasmon enhanced fluorescence detecting apparatus of the present invention does not require a total reflection optical system including components such as a prism as is required in a surface plasmon enhanced fluorescence detecting apparatus. Therefore, the configuration of the apparatus is simplified, and the apparatus can be produced at low cost.

### BRIEF DESCRIPTION OF THE DRAWINGS

FIG. 1 is a sectional diagram that schematically illustrates an enhancing fluorescent particle for localized plasmon enhanced fluorescence detection.

FIG. 2A is a plan view that schematically illustrates the configuration of an immunochromatographic measuring carrier.

FIG. 2B is a sectional diagram taken along line IIA-IIA of FIG. 2A.

FIG. 3 is a collection of diagrams that illustrates the steps of an immunochromatographic measuring process.

FIG. 4 is a side view that schematically illustrates the configuration of a localized plasmon enhanced fluorescence detecting apparatus.

FIG. 5 is a sectional diagram that schematically illustrates a conventional fluorescent label.

### BEST MODE FOR CARRYING OUT THE INVENTION

Hereinafter, embodiments of the present invention will be described in detail with reference to the attached drawings.

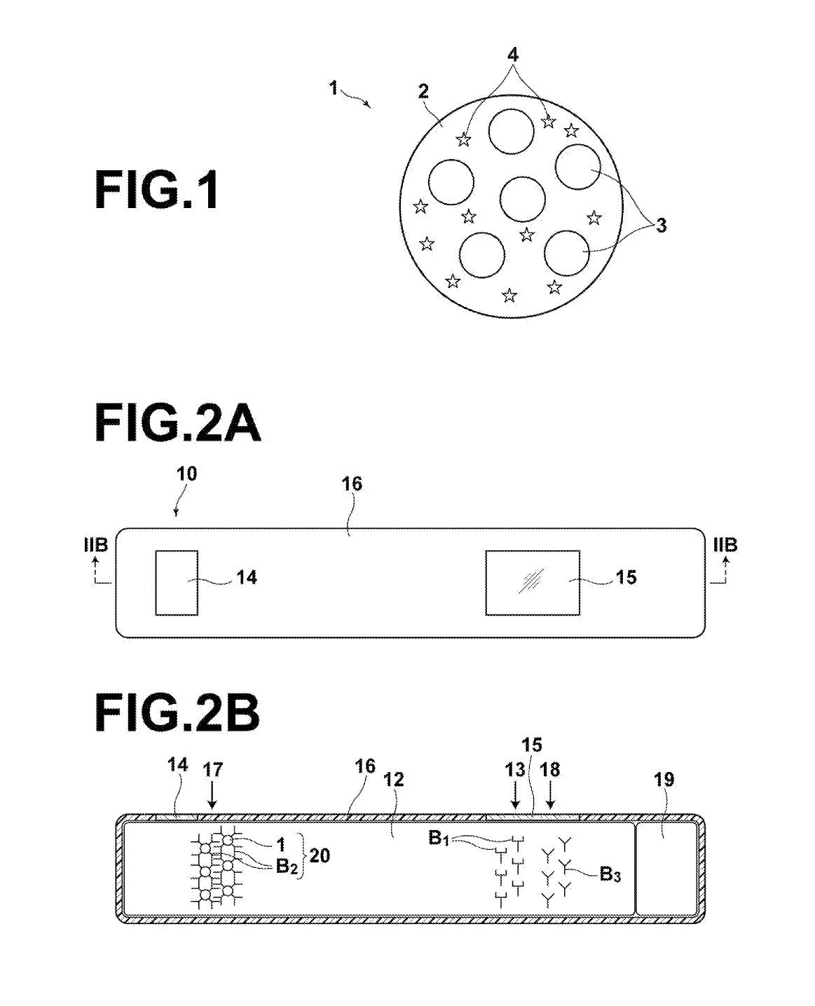

FIG. 1 is a sectional diagram that schematically illustrates an enhancing fluorescent particle for localized plasmon enhanced fluorescence detection according to an embodiment of the present invention.

As illustrated in FIG. 1, the enhancing fluorescent particle 1 includes a plurality of fine metal particles 3 and a plurality of fluorescent dye molecules 4 which are dispersed and enveloped in a light transmitting dielectric material 2. When the enhancing fluorescent particle 1 receives irradiation of light, localized plasmon resonance is generated at the fine metal particles 3 to generate an enhancing electrical field due to the localized plasmon resonance, and fluorescence which is amplified by the electric field enhancing effect is generated by the fluorescent dye molecules 4.

The light transmitting dielectric material 2 needs only to be that which transmits fluorescence emitted by the fluorescent dye molecules enveloped therein and excitation light that excites the fluorescent dye molecules. SiO₂ and light transmitting resins are particularly preferable. Examples of light transmitting resin materials include: polymethylmethacrylate (PMMA); and cycloolefin series resins. Here, transmission of fluorescence and excitation light means that the transmissivity of the material with respect to the peak wavelength of fluorescence is 85% or greater and the transmissivity of the material with respect to the peak wavelength of excitation light is 85% or greater.

The material that constitutes the fine metal particles 3 needs only to be that which generates localized plasmon resonance when irradiated with light. Preferred examples of such materials include: Au; Ag; Cu; Al; Pt; Ni; Ti; and alloys having at least one of the above metals as a main component.

The fluorescent dye molecules 4 are Cy3, Cy5, etc. The size of the fluorescent dye molecules 4 is approximately up to 1 nm.

It is preferable for the particle size of the enhancing fluorescent particles to be 5300 nm or less, from the viewpoint of dispersion time. It is preferable for the particle size of the enhancing fluorescent particles to be within a range from 100 nm to 500 nm.

There is a problem that metal quenching will occur and fluorescence emission will be suppressed if a fluorescent dye molecule is within a distance of less than 10 nm from a fine metal particle. Meanwhile, the electric field enhancing effect due to localized plasmon resonance at the fine metal particles is effective within a range from the surfaces of the fine metal particles to a distance approximately equal to the particle size of the fine metal particles.

It is desirable for the size of the fine metal particles to be greater than the distance at which metal quenching occurs, such that the electric field enhancing effect can be obtained for fluorescent dye molecules which are present at distances greater than 10 nm from the fine metal particles. Accordingly, it is desirable for the particle size of the fine metal particles to be greater than 10 nm. In the case of fine metal particles formed by practical metals, absorption and plasmon resonance can be caused to occur with respect to all wavelengths within the visible light spectrum if the particle size is within a range from 10 nm to 40 nm (refer to A. Iwakoshi, “Application of Metal Nanoparticles to Paint Colorants”, left column of p. 35 of TECHNO-COSMOS, Vol. 21, pp. 32-38, 2008). Based on these two conditions, it is desirable for the particle size of the fine metal particles to be greater than 10 nm and 40 nm or less.

In order to obtain a greater electric field enhancing effect due to localized plasmon resonance, it desirable for the fine metal particles to be provided densely. This is because the electric field enhancing effect is exerted within a range about the fine metal particles approximately equal in distance to the particle size thereof, and therefore, the number of ranges in which the electric field enhancing effect is not exerted will increase if the fine metal particles are provided sparsely. Meanwhile, if the distance between a tine metal particle and a fluorescent dye molecule is less than 10 nm, the aforementioned metal quenching will occur. Accordingly, it is necessary for the fluorescent dye molecules to be present at positions 10 nm or further from the fine metal molecules. That is, metal quenching will not occur if the fluorescent dye molecules are present at locations where the distances among the fine metal particles are at least 20 nm.

In order to realize both of these conditions, it is necessary to precisely limit the percentage of volume of the fine metal particles. It is easy to understand the percentage of volume of the fine metal particles if it is considered as a case in which fine metal particles coated with 20 nm thick quenching preventing layers (formed by transparent dielectric films, for example) are packed within the enhancing fluorescent particles. Specifically, if arranged in a grid, the fine metal particles can be packed at at least 5% or more grid points. In this state, the distances among the fine metal particles at the most proximal locations will be 20 nm, but the distance between the fine metal particles on the diagonal of the grid will be significantly greater than 20 nm. If the distances among the fine metal particles become too great, the electric field enhancing effect will deteriorate. Therefore, it is preferable for the distances among the fine metal particles to be at least 20 nm, but not excessively great. In order to achieve this state, the fine metal particles coated with 10 nm thick quenching preventing layers may be closely packed. In this case, the percentage of volume of the fine metal particles is approximately 40%, the distances among the fine metal particles are 20 nm or greater in all directions, but do not greatly exceed 20 nm.

Two examples of methods for producing the enhancing fluorescent particles that have both the fine metal particles and the fluorescent dye molecules enveloped in a light transmitting dielectric material will be described.

The first method forms dielectric films from SiO₂ film, and includes the following steps (1) through (3).

(1) Synthesizing gold colloids which will become the fine metal particles 3:

(2) Substituting the surface dispersion agent of the gold colloids (from citric acid to siloxane):

2.5 ml of a 1 mmol aqueous solution of APS ((3-aminopropyl)trimethoxysilane) is added to 500 mL (milliliters) of a 5·10⁻¹ mol gold colloid aqueous solution, and stirred for 15 minutes to substitute the citric acid on the surfaces of the gold colloids.

(3) Modifying the surfaces of the gold colloids with SiO₂:

20 ml of an aqueous solution containing sodium silicate at 0.54% by weight with a pH adjusted to be within a range from 10 to 11 is added to the gold colloid aqueous solution following step (2), then stirred vigorously. 4 nm thick SiO₂ coating films are formed after 24 hours. This solution is concentrated to 30 ml by centrifugal separation. 170 mL of ethanol is added to the concentrated solution. Further, 0.6 mL if NH₄OH (28%) is dripped into the concentrated solution, 80 μL (microliters) of TES (tetraethoxysilane) is added to the concentrated solution, and then the mixture is stirred slowly for 24 hours, to form 20 nm thick SiO₂ coating films. At this time, organic dye molecules are naturally immobilized within silica particles, by mixing a dye-silane coupling agent complex in which an organic dye and a silane coupling agent are bound by covalent bonds simultaneously with TES (TEOS) (refer to H. Aizawa et al., “Development of Silica Nanoparticles for Diagnostic Testing”, left column of p. 18 of Furukawa Electric Group Digest, No. 121, pp. 11-22, 2008). Note that in a strict sense, the number of fine metal particles included in silica cannot be controlled in this production method. Accordingly, it is necessary to perform purification, separation, and selection by centrifugal separation, electrophoresis, and liquid chromatography. In actuality, the selection is comparatively simple in the case that the particle sizes of the fine metal particles are matched in the initial stage.

A second method, which is a case in which the light transmitting material is formed by a polymer, will be described. The second method includes the following steps (1) through (3).

(1) Redispersing gold nanoparticles which will become the fine metal particles 3 into DMF (N,N-dimethylformamide):

1 mL of an aqueous dispersion that contains citric acid stabilized gold nanoparticles having an average particle size of approximately 30 nm at a concentration of at most 360 pmol (=7·10⁻¹¹% by weight) is prepared. The aqueous dispersion undergoes centrifugal separation, and 0.95 mL of the supernatant is discarded. The remaining dark red, viscid precipitate is redispersed within 1 mL of DMF. Note that excessive citric acid ions inhibit encapsulation of particles. In addition, it is favorable to cleanse the particles prior to adding DMF in the case that particles having small particle sizes are employed.

(2) Encapsulating gold nanoparticles:

10 μL of a DMF solution (approximately 10⁻² g.mL) of a polystyrene-polyacrylic acid block copolymer (in which the polystyrene is approximately 100-mer and the polyacrylic acid is approximately 13-mer) is added to the citric acid stabilized gold nano particles having an average particle size of approximately 30 nm. 200 μL of water is added to the mixture by a syringe pump at a flow rate of 8.3 μL/min, and then vigorously stirred. The color of the mixture gradually turns violet when stirred for 10 minutes. At this point in time 5 μL of a DMF solution containing 1% by weight of dodecanthiol is added to the mixture, and then the mixture is stirred for 24 hours. 3 mL of water is added to the mixture by a syringe pump at a flow rate of 2 mL/hour thereafter.

Next, the DMF is removed over 24 hours by dialysis. Then, 72 μL of an EDC (1-ethyl-3-(3-dimethylaminopropyl) carbodiimide) solution (0.1% by weight with respect to water: 24 nmol) is added at once while stirring the mixture. Stirring is continued for 30 minutes, at which point 144 μL of an EDODEA (2,2′-(ethylenedioxy; bis(ethylamine)) solution (0.1% by weight with respect to water: 96 nmol) is added at once, and the mixture is stirred.

Thereafter, reagents are removed over 24 hours by dialysis, the mixture undergoes centrifugal separation for 30 minutes at 4000 G, and supernatant corresponding to 80% of the volume is discarded. An amount of water having the same volume as the discarded supernatant is added, and centrifugal separation is performed again under the same conditions. After repeating the steps from centrifugal separation to the next centrifugal separation three Limes or more, a coating of cross linked polystyrene-polyacrylic acid block copolymer is formed about the gold nanoparticles (fine metal particles). Thereby, polystyrene particles, in which a plurality of gold nanoparticles are enveloped, are obtained.

(3) Impregnating fluorescent dye molecules:

Fluorescent dye molecules are impregnated Into the particles having the fine metal particles enveloped therein, produced by the steps described above. The impregnation involves the following procedures.

A 0.1% solid in phosphate polystyrene solution (pH 7.0) is prepared employing the particles having the fine metal particles enveloped therein, produced by the steps described above.

Next, an acetic ether solution (1 mL) that contains 0.3 mg of fluorescent dye molecules (NK-2014 by Hayashibara Biochemical Research Laboratory, excitation wavelength: 780 nm) is produced.

The fluorescent dye solution and the polystyrene solution are mixed, impregnation is performed while evaporating the mixture, centrifugal separation (twice at 15000 rpm and 4° C. for 20 minutes) is performed, and the supernatant is removed.

Enhancing fluorescent particles, in which a plurality of fluorescent dye molecules and a plurality of metal particles are enveloped in polystyrene, which has a function of transmitting fluorescence emitted by the fluorescent dye molecules, are obtained by the above procedures. The particle size of the enhancing fluorescent particles which are produced by impregnating the fluorescent dye molecules in the polystyrene particles is the same as the particle size of the polystyrene particles (φ150 nm in the example described above).

The enhancing fluorescent particles have a plurality of fine metal particles enveloped therein. Therefore, the electric field enhancing effect due to localized plasmon by each individual fine metal particle overlap within the entirety of the interiors of the particles. Accordingly, the electric field enhancing effect can be increased compared to a case in which a single fine metal particle is employed. In addition, the enhancing fluorescent particles have a plurality of fluorescent dye molecules enveloped therein. Therefore, the amount of emitted fluorescence can be significantly increased compared to a case in which a single fluorescent dye molecule is employed as a fluorescent label. That is, the enhancing fluorescent particle of the present invention can obtain amplified fluorescence which is synergistically increased by the electric field enhancing effect of the plurality of fine metal particles and the fluorescence increasing effect of employing the plurality of fluorescent dye molecules.

In the case that the enhancing fluorescent particles 1 are employed as fluorescent labels in antigen antibody reactions, secondary antibodies that specifically bind to antigens are immobilized on the surfaces of the enhancing fluorescent particles 1, to be employed as labeling secondary antibodies (labeling binding substance).

Next, an immunochromatographic measuring carrier 10 will be described as a localized plasmon enhanced fluorescence detecting carrier equipped with the enhancing fluorescent particles of the present invention. FIG. 2A is a plan view that schematically illustrates the immunochromatographic measuring carrier 10, and FIG. 2B is a sectional diagram taken along line IIB-IIB of FIG. 2A that schematically illustrates the configuration of the carrier 10.

The mmunochromatographic measuring carrier 10 is equipped with a sample holding member (case) 16 having a chromatography medium 12 as a flow channel for a sample liquid. A sensor region (sensor portion) 13 imparted with a first binding substance B₁ that specifically binds with a detection target substance A is provided at a portion of the chromatography medium 12. A labeling binding substance supply portion 17 is provided in the chromatography medium 12 upstream of the sensor region 13. The case 16 is provided at least with an inlet 14 for injecting a sample liquid S into the chromatography medium 12 and a window portion 15 through which the sensor region 13 can be visually confirmed.

Here, the chromatography medium 12 is constituted by a nitrocellulose membrane. The membrane 12 is housed within the case 16 such that the sensor region can be visually confirmed through the window portion 15. In the present embodiment, the detection target substance A is a predetermined antigen, and primary antibodies are imparted to the sensor region 13 of the chromatography medium 12 as the first binding substance B₁ that specifically binds with the predetermined antigens A, which is the detection target substance.

A labeling binding substance 20 is constituted by a second binding substance B₂ which are labeled by the enhancing fluorescent particles 1. The second binding substance B₂ is secondary antibodies B₂ that specifically bind with the antigens A, and bind to epitopes (antigen determining group) of the antigens A different from those that bind with the first binding substance B₁.

Further, an examination completion confirming region 18 imparted with reference antibodies B₃ that bind with the secondary antibodies B₂ is provided in the membrane 12 downstream of the sensor region 13. The confirming region 18 is also configured to be visually confirmable through the window portion 15 of the case 16. In addition, an absorbing pad 19 is provided at the most downstream end portion of the case 16 such that the sample liquid S will not flow in reverse.

The primary antibodies B₁, the secondary antibodies B₂, and the reference antibodies B₃ are respectively imparted to predetermined regions of the membrane 12. The manner in which they are imparted may simply be that in which the antibodies are imparted to each region. However, there is a possibility that reaction results cannot be confirmed if the secondary antibodies B₂ and the reference antibodies B₃ washed away due to osmotic movement within the membrane. Therefore, it is desirable for the secondary antibodies B₂ and the reference antibodies B₃ to be immobilized to the respective regions of the membrane 12 by a technique such as amino coupling.

An immunochromatographic measuring process that confirms whether the predetermined antigen A is present within a sample liquid S and employs the immunochromatographic measuring carrier 10 of the embodiment of the present invention will be described.

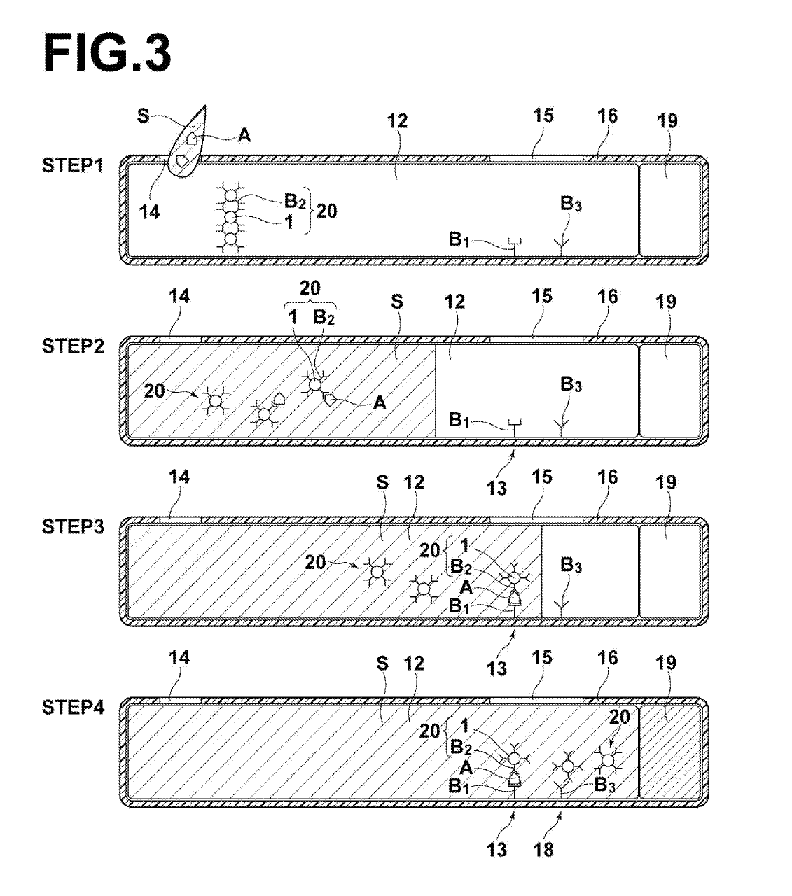

FIG. 3 is a collection of diagrams that illustrates the steps of the immunochromatographic measuring process. In FIG. 3, only one or several of the antigens A, the labeling binding substance 20, and the primary antibodies are schematically illustrated to facilitate visual understanding of the movement of the antigens A and the labeling binding substance 20, the bonding states of the primary antibodies and the reference antibodies, etc.

The sample liquid S is blood, urine, nasal mucous, or the like, which is a target of examination regarding whether the detection target substance is contained therein.

Step 1: The sample liquid S is dripped into the membrane 12 through the inlet 14. Here, a case will be described in which the sample liquid S includes the antigen A to be detected.

Step 2: The sample liquid S osmoses into the membrane 12 by capillary action. The antigens A within the sample liquid S bind with the secondary antibodies B₂ of the labeling binding substance 20 imparted in the vicinity of the inlet 14 of the membrane 12, and osmose through the membrane 12 toward the sensor region 13. At this time, the labeling binding substance 20 which is not bound to the antigens A also flows toward the sensor region 13.

Step 3: The sample liquid S gradually flows along the membrane 12 toward the sensor region 13, and the antigens A, which are bound to the labeling secondary antibodies B₂, bind with the primary antibodies B₁, which are immobilized onto the sensor region 13. So called sandwich configurations, in which the antigens A are sandwiched between the primary antibodies B₁ and the labeling secondary antibodies B₂, are formed.

Step 4: A portion of the labeling secondary antibodies B₂ of the labeling binding substance 20 that did not bind with the antigens A bind with the reference antibodies B₃. When the secondary antibodies B₂ bind with the reference antibodies B₃, fluorescence from the enhancing fluorescent particles 1 can be visually confirmed at the examination completion confirming region 18. Thereby, it can be confirmed that the sample liquid has flowed to the sensor region 13 and the confirming region 18.

The results of the immune reaction are visually observed through the window portion 15. Note that in the case that sufficient fluorescence is not emitted by light, such as sunlight and room light, light from other excitation light irradiating means (light from a xenon lamp or a halogen lamp, which is commonly employed as an illuminating source in microscopes) may be caused to enter the carrier 10, to observe amplified fluorescence from the enhancing fluorescent particles.

The immunochromatographic measuring carrier 10 employs the enhancing fluorescent particles 1 as fluorescent labels. Therefore, amplified fluorescence which is synergistically increased by the electric field enhancing effect of the plurality of fine metal particles and the fluorescence increasing effect of employing the plurality of fluorescent dye molecules can be obtained. Accordingly, highly sensitive measurements can be performed.

Note that a fluorescence detecting apparatus may be configured with an excitation light irradiating means that irradiates excitation light onto the enhancing fluorescent particles and a fluorescence detecting means that detects fluorescence from the enhancing fluorescent particles, in the case that the amount of a detection target is extremely small and therefore the resulting fluorescence is week although amplified, or in order to always perform measurements at a constant level of accuracy or greater.

Note that in the immunochromatographic measuring carrier, which is the embodiment of the localized plasmon resonance enhanced fluorescence detecting carrier of the present invention, the membrane 12 is imparted with the labeling binding substance (labeling secondary antibodies) in advance. However, it is not necessary for the membrane 12 to be imparted with the labeling secondary antibodies. In this case, a sample liquid may be injected to cause antigens and the primary antibodies to bond, and then a solution that contains the labeling secondary antibodies may be injected through the inlet to cause the antigens which are bound to the primary antibodies to bind with the labeling secondary antibodies. As another alternative, a sample liquid may be mixed with a solution that contains the labeling secondary antibodies in advance, and the mixture may be injected through the inlet in a state in which antigens within the sample liquid and the labeling secondary antibodies are bound to each other.

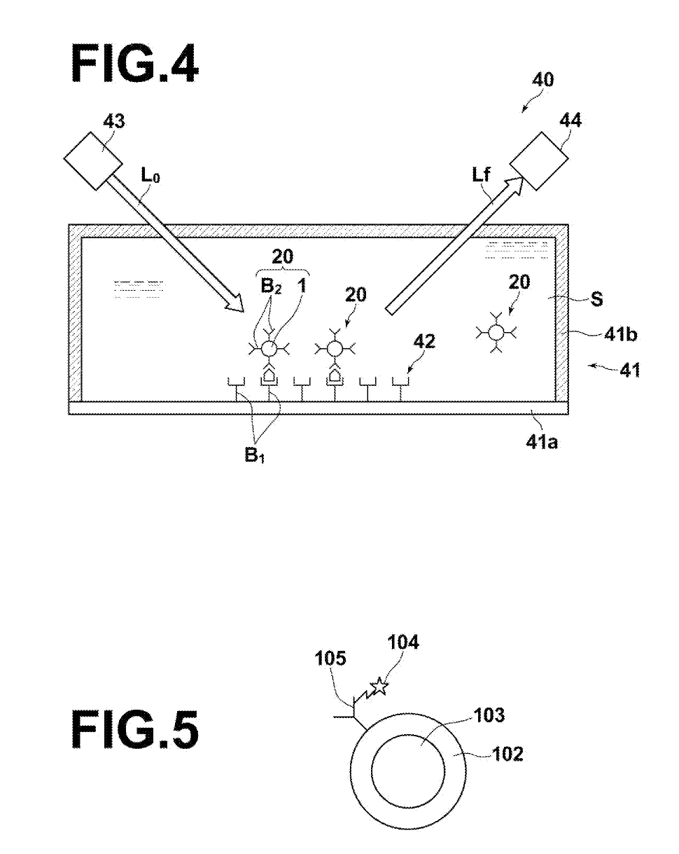

FIG. 4 is a side view that schematically illustrates the configuration of a localized plasmon enhanced fluorescence detecting apparatus (hereinafter, simply referred to as “fluorescence detecting apparatus”) 40.

As illustrated in FIG. 4, the fluorescence detecting apparatus 40 is equipped with: a sample cell 41 constituted by a bottom surface 41a provided with a sensor portion 42, on which a first binding substance B₁ that specifically binds with a detection target substance A within a sample liquid S is immobilized, and a sample holding portion 41b formed by a transparent member that holds the sample liquid S on the sensor portion 42; a light source 43 such as a semiconductor laser that irradiates an excitation light beam L₀, toward the sensor portion 42 of the sample cell 41; and a photodetector 44 that detects fluorescence L_{f} emitted from the sensor portion 42 as will be described later.

An example of the detection target substance A to be detected by the fluorescence detecting apparatus 40 is CRP antigens (molecular weight: 110,000 Da). In this case, monoclonal antibodies that specifically bind with the antigens A are immobilized onto the bottom surface 41a of the sample cell 41 as primary antibodies B₁. The primary antibodies B₁ are immobilized onto bottom surface 41a of the sample cell by the amine coupling method via PEG's having carboxylized ends.

The amine coupling method includes the following steps (1) through (3), for example. Note that the following example is for a case in which a 30 μL (microliter) cuvette/cell is employed.

(1) Activation of —COOH Groups at the Ends of Linkers:

30 μl of a solution containing equal volumes of a 0.1M NHS (N-hydrooxysuccinimide) solution and a 0.4M EDC (1-ethyl-3-(3-dimethylamminopropyl)carbodiimide) solution are added, and left still at room temperature for 30 minutes.

(2) Immobilization of Primary Antibodies:

Cleansing is performed five times with a PBS buffer (pH: 7.4). Then, 30 μl of a solution containing the primary antibodies (500 ug/ml) is added, and left still for 30 to 60 minutes at room temperature.

(3) Blocking of Non Reacted —COOH Groups:

Cleansing is performed five times with a PBS buffer (pH: 7.4). Then, 30 μl of a 1M ethanol amine solution (pH: 8.5) is added, and left still for 20 minutes at room temperature. Thereafter, cleansing is performed five times with a PBS buffer (pH: 7.4).

When detecting the CRP antigens A, a great number of the enhancing fluorescent particles 1 with secondary antibodies (monoclonal antibodies) having epitopes different from the secondary antibodies B₁ bound to the surfaces thereof are mixed into the sample liquid S as the second binding substance B₂ that specifically binds with the CRP antigens A.

The light source 43 is not limited to being a semiconductor laser, and may be selected as appropriate from among other known light sources. LAS-1000 plus by FUJIFILM KK may be favorably employed as the photodetector 44. However, the photodetector 30 is not limited to the above, and may be selected appropriately according to detection conditions. Examples of alternative photodetectors include: CCD's; PD's (photodiodes); photoelectron multipliers; and c-MOS's. The excitation wavelength is determined according to the fluorescent dye molecules which are enveloped within the enhancing fluorescent particles.

A case in which the CRP antigens A included in the sample liquid S using the above fluorescent detecting apparatus will be described.

First, the sample liquid S is caused to flow within the sample cell 41. Next, the enhancing fluorescent particles 1 having the secondary antibodies B₂ bound to the surfaces thereof are caused to flow into the sample cell 41 as a binding substance imparted with fluorescent labels.

After the two steps above, the excitation light beam L₀ is irradiated toward the sensor portion 42 of the sample cell 41 from the light source 43. At this time, if the CRP antigens A is present within the sample liquid S and have bound to the primary antibodies B₁ of the sensor portion 42, the secondary antibodies B₂ of the labeling binding substance 20 will further bind with the antigens A. The enhancing fluorescent particles 1, which are the labels of the secondary antibodies B₂, will be excited by the excitation light beam L₀. The enhancing fluorescent particles 1 which are excited in this manner emit fluorescence L_{f}, and the fluorescence L_{f} is detected by the photodetector 44. The amount of detected fluorescence L_{f} will become greater as the amount of excited enhancing fluorescent particles 1 becomes greater, that is, as the amount of CRP antigens A is greater. Therefore, the CRP antigens can be quantitatively analyzed based on the detected amount of light.

When the excitation light beam L₀ is irradiated, localized plasmon is excited by the plurality of fine metal particles 3 within the enhancing fluorescent particles 1 which are present in the vicinity of the sensor portion 42 of the sample cell 41. The fluorescence L_{f} is amplified by the electric field enhancing effect of the localized plasmon. The CRP antigens A, which are detection targets, can be detected at high sensitivity because the fluorescence L_{f} is amplified in this manner.

The fluorescence detecting apparatus and the fluorescence detecting method of the present embodiment employs the enhancing fluorescent particles 1. Therefore, amplified fluorescence which is synergistically increased by the electric field enhancing effect of the plurality of fine metal particles and the fluorescence increasing effect of employing the plurality of fluorescent dye molecules can be obtained. Accordingly, highly sensitive measurements can be performed.

The fluorescence sensor of the present embodiment does not require a total reflection optical system that includes components such as a prism, as is necessary in a surface plasmon enhanced fluorescence sensor. Therefore, the configuration of the apparatus is simplified, and the apparatus can be produced at low cost.

The immunochromatographic measuring carrier and the fluorescence detecting apparatus of the embodiments described above are those that detect fluorescence by a detection method referred to as the sandwich method. However, a fluorescence detecting apparatus that detect fluorescence by the so called competition method can be obtained, by mixing a labeling binding substance, in which fluorescent particles F are modified with a third binding substance that bind specifically with the first binding substance (primary antibodies B₁), with a sample liquid S, instead of the second binding substance (secondary antibodies B₂) that bind specifically with the antigens in the configuration illustrated in FIG. 1. That is, in this case, the third binding substance and antigens A compete when binding with the primary antibodies B₁. Therefore, the number of fluorescent particles that bind with the sensor portion becomes smaller as the amount of the antigens A is greater, and the amount of fluorescence L_{f} which is detected decreases. In this case as well, the antigens A can be quantitatively analyzed based on the detected amount of fluorescence.

What is claimed is:

1. An enhancing fluorescent particle for use in localized plasmon enhanced fluorescence detection, comprising:
a plurality of fine metal particles;
a plurality of fluorescent dye molecules; and
a light transmitting dielectric material;
the plurality of fine metal particles and the plurality of fluorescent dye molecules being dispersed and enveloped in the light transmitting dielectric material; and
the particle size of the fine metal particles being greater than 10 nm and 40 nm or less, and the volume occupied by the fine metal particles in the light transmitting dielectric material is within a range from 5% to 40%.

2. An enhancing fluorescent particle as defined in claim 1, wherein:
the light transmitting dielectric material is one of SiO₂ and a transparent resin.

3. A localized plasmon enhanced fluorescence detecting carrier, comprising:
a sample holding member having a flow channel through which a sample fluid is caused to flow;
a sensor portion, at which a first binding substance that specifically binds with a detection target substance within the sample fluid is immobilized, provided within the flow channel; and
a labeling binding substance supply portion, at which a labeling binding substance is supplied, provided within the flow channel upstream of the sensor portion;
the labeling binding substance being one of a second binding substance that specifically binds with the detection target substance and a third binding substance that specifically binds with the first binding substance in competition with the detection target substance, to which enhancing fluorescent particles as defined in claim 1 are imparted.

4. A localized plasmon enhanced fluorescence detecting carrier, comprising:
a sample holding member having a flow channel through which a sample fluid is caused to flow;
a sensor portion, at which a first binding substance that specifically binds with a detection target substance within the sample fluid is immobilized, provided within the flow channel; and
a labeling binding substance supply portion, at which a labeling binding substance is supplied, provided within the flow channel upstream of the sensor portion;
the labeling binding substance being one of a second binding substance that specifically binds with the detection target substance and a third binding substance that specifically binds with the first binding substance in competition with the detection target substance, to which enhancing fluorescent particles as defined in claim 2 are imparted.

5. A localized plasmon enhanced fluorescence measuring apparatus, comprising:
a localized plasmon enhanced fluorescence detecting carrier as defined in claim 3;
a light source that irradiates excitation light that excites the fluorescent particles onto the sensor portion; and
a light detecting section that detects fluorescence emitted by the fluorescent particles excited by the excitation light.

6. A localized plasmon enhanced fluorescence measuring apparatus, comprising:
a localized plasmon enhanced fluorescence detecting carrier as defined in claim 4;
a light source that irradiates excitation light that excites the fluorescent particles onto the sensor portion; and
a light detecting section that detects fluorescence emitted by the fluorescent particles excited by the excitation light.

7. A fluorescence detecting method, comprising:
causing a sample liquid to contact a sensor portion of a sample cell, a first binding substance that specifically binds with a detection target substance being immobilized on the sensor portion, and the sample liquid including a labeled binding substance, which is one of a second binding substance that specifically binds with the detection target substance and a third binding substance that specifically binds with the first binding substance in competition with the detection target substance, labeled with fluorescent labels;
irradiating light onto the sensor portion; and
detecting fluorescence emitted by the fluorescent labels, which are excited by the light being irradiated thereon;
the enhancing fluorescent particles as defined in claim 1 being employed as the fluorescent, and fluorescence enhanced by localized plasmon resonance being detected.
